(19) United States
(12) Patent Application Publication
(10) Pub. No.: US 2011/0158489 A1
(43) Pub. Date: Jun. 30, 2011

(54) DETECTION DEVICES AND DETECTION METHOD

(75) Inventors: YUNG-SHUN HUANG, TAICHUNG COUNTY (TW); MIN SHIH, KAOHSIUNG CITY (TW); CHIA HUNG WU, KAOHSIUNG CITY (TW); YIH-NEN JENG, TAINAN CITY (TW)

(73) Assignee: INDUSTRIAL TECHNOLOGY RESEARCH INSTITUTE, HSINCHU (TW)

(21) Appl. No.: 12/651,396

(22) Filed: Dec. 31, 2009

(51) Int. Cl. G06K 9/00; G06K 9/36; G06K 9/40

(52) U.S. Cl. 382/128; 382/276; 382/280

(57) ABSTRACT

A detection device for detecting specific operation information of a subject is provided and includes an image capturing unit, an image processing unit, a signal processing unit, and a detection unit. The image capturing unit captures pictures of the subject to generate image signals respectively. Each of the image signals has gray-level values. The image processing unit sums the gray-level values of each of the image signals to obtain a brightness value of the corresponding image signal. The signal processing unit generates an action signal according to the brightness values, removes a non-periodic component of the action signal, and calculates a spectrum of the action signal whose non-periodic component is removed. The detection unit checks the spectrum according to a detection rule to obtain the specific operation information of the subject.

### BACKGROUND OF THE INVENTION

1. Field of the Invention

The invention relates to a detection device, and more particularly to a detection device which detects operation information of an object according to pictures thereof without touching the object.

2. Description of the Related Art

Operation information of an object can be obtained according to its action data thereof. For example, operation information of aircraft, ship, electric generators, gas turbines, bridges, and buildings can be obtained according to their action data, such as moving or vibration data. According to the obtained operation information, it is determined whether the object is operating safely or expectably. Moreover, for a living body, some operations of organs or physiological actions induce the some portions of the living body to move or vibrate. For example, the pulse on the carotid artery of a human can induce undulation of the skin near the carotid artery. Accordingly, the action data, such as moving or vibration data of the living body, can be reference to determine the physiological state or mentality of the living body.

Thus, it is desired to provide a detection device which can capture pictures of a subject to obtain action data of a subject and detect the operation information of the subject.

### BRIEF SUMMARY OF THE INVENTION

An exemplary embodiment of a detection device for detecting specific operation information of a subject is provided. The detection device comprises an image capturing unit, an image processing unit, a signal processing unit, and a detection unit. The image capturing unit captures a plurality of pictures of the subject to generate image signals respectively. Each of the image signals comprises a plurality of gray-level values. The image processing unit receives the image signals and sums the gray-level values of each of the image signals to obtain a brightness value of the corresponding image signal. The signal processing unit receives the brightness values, generates an action signal according to the brightness values, removes a non-periodic component of the action signal, and calculates a spectrum of the action signal whose non-periodic component is removed. The detection unit checks the spectrum according to the detection rule to obtain the specific operation information of the subject.

In one embodiment, the subject is a living body, and the specific operation information comprises an undulation frequency of skin of a neck near a carotid artery of the living body. The detection unit obtains a pulse rate of the living body according to the undulation frequency.

In another embodiment, the subject is a living body, and the specific operation information comprises a moving frequency of a neck of the living body. The detection unit obtains a respiratory rate of the living body according to the moving frequency.

In further another embodiment, the subject has a shaft, and the specific operation information comprises a vibration rate of the subject. The detection unit obtains a rotation rate of the shaft according to the vibration rate of the subject.

In another embodiment, the subject has an engine, and the specific operation information comprises a vibration rate of the engine. The detection unit obtains an idle speed of the engine according to the vibration rate of the engine.

An exemplary embodiment of a detection method for detecting specific operation information of a subject is provided. The detection method comprises the steps of capturing a plurality of pictures of the subject to obtain image signals respectively, each of the image signals comprises a plurality of gray-level values; for each of the image signals, summing the gray-level values of the image signal to obtain a brightness value; generating an action signal according to the brightness values; removing a non-periodic component of the action signal; calculating a spectrum of the action signal whose non-periodic component is removed; and checking the spectrum according to a detection rule to obtain the specific operation information of the subject.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 shows an exemplary embodiment of a detection device;

FIG. 2 shows an example of the detection device for a living body;

FIG. 3 shows a picture of the living body in FIG. 2;

FIG. 4 shows a spectrum for the living body;

FIG. 5 shows an example of the detection device for a servo-motor;

FIG. 6 shows a picture of the servo-motor in FIG. 5;

FIG. 7 shows a spectrum for the servo-motor;

FIG. 8 shows an example of the detection device for a motorcycle;

FIG. 9 shows a picture of the motorcycle in FIG. 5;

FIG. 10 shows a spectrum for the motorcycle; and

FIG. 11 shows an exemplary embodiment of a detection method.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

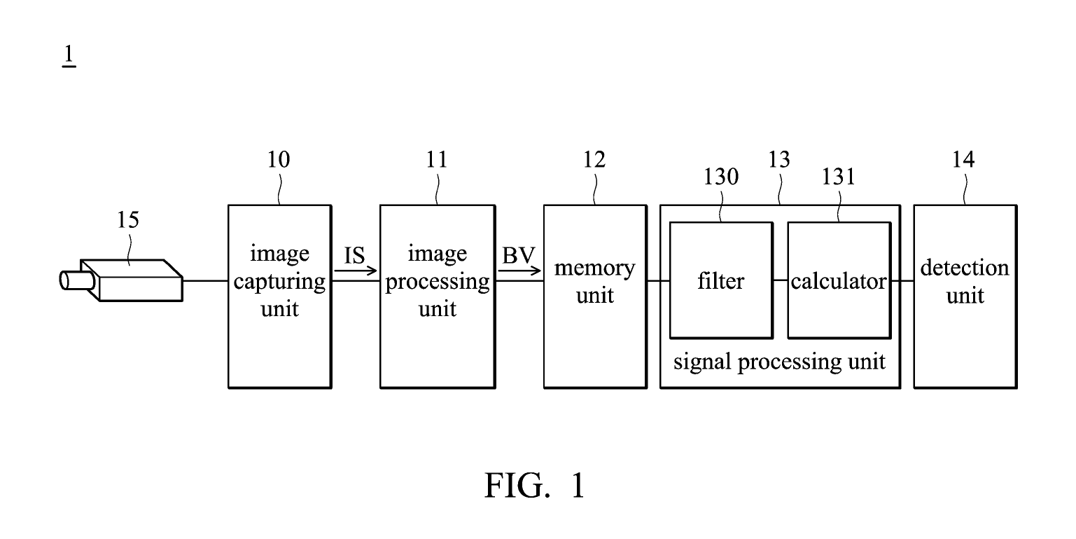

Detection devices are provided. In an exemplary embodiment of a detection device in FIG. 1, a detection device 1 is used to detect specific operation information of a subject and comprises an image capturing unit 10, an image processing unit 11, a memory unit 12, a signal processing unit 13, a detection unit 14, and a camera 15. In the embodiment, the subject can be an object or a living body. Referring to FIG. 1, the image capturing unit 10 captures a plurality of pictures of a subject via a camera 15 to generate image signals IS respectively. In another embodiment, after capturing the pictures of the subjects, for each picture of the subject, the image capturing unit 10 selects a specific area of the picture and generates a corresponding image signal IS according to an image of the specific area of the picture. Thus, the image capturing unit 10 generates image signals IS which represent the pictures of the subject respectively. Each of the image signals IS comprises a plurality of pixels with gray-level values.

The image processing unit 11 receives the image signals IS and sums the gray-level values of the pixels of each of the image signals IS to obtain a brightness value BV of the corresponding image signal. For example, each picture of the subject or the selected specific area of each picture of the subject, which is to generate a corresponding image signal IS, is formed by 3×3 pixels. Thus, the corresponding image signal IS comprises 9 gray-level values. The image processing unit 11 sums the 9 gray-level values to obtain a corresponding brightness value BV. Due to the summing operation to the gray-level values of each image signal IS, the brightness of each picture can be represented by a range of 0˜2295 (255×9) and shown by the corresponding brightness value BV. Thus, the variation between the pictures of the subject can be emphasized and observed easily.

The memory unit 12 is coupled to the image processing unit 11 and receives the brightness values BV from the image processing unit 11. When the memory unit 12 collects the brightness values BV of a predetermined number, the memory unit 12 outputs the brightness values BV of the predetermined number to the signal processing unit 13. For example, the image capturing unit 10 captures 18 pictures of the subject per one second, and 18 brightness values BV for the 18 pictures are thus obtained. When the memory unit 12 collects the brightness values BV in the least 25 seconds, that is when the memory unit 12 collects 450 (25*18) brightness values BV (the predetermined number is equal to 450), the memory unit 12 output the 450 brightness values BV to the signal processing unit 13. In some embodiments, the predetermined number and the refresh rate of the memory unit 12 are determined according to system requirements.

The signal processing unit 13 receives the brightness values BV from the memory unit 12. According to the above example, when the memory unit 12 collects 450 brightness values BV, the memory unit 12 output the 450 brightness values BV to the signal processing unit 13. The signal processing unit 13 then generates an action signal according to the 450 brightness values BV, wherein the action signal is composed of the 450 brightness values BV. Referring to FIG. 1, the signal processing unit 13 comprises a filter 130 and calculator 131. The filter 130 removes a non-periodic component of the action signal. In the embodiment, the filter 130 removes the non-periodic component of the action signal by an iterative Gaussian smoothing method. Then, the calculator 131 calculates a spectrum of the action signal whose non-periodic component is removed. In the embodiment, the calculator 131 calculates the spectrum by performing a Fast Fourier Transform algorithm to the action signal whose non-periodic component is removed.

After the spectrum is obtained, the detection unit 14 checks the spectrum according to a detection rule to obtain the specific operation information of the subject. In the embodiment, the detection rule comprises looking for a frequency range in the spectrum or/and determining at least one frequency amplitude in the frequency range in the spectrum. The values of the frequency range and the at least one frequency amplitude are determined according to the type of the subject and the characteristic of the subject.

According to the embodiment of FIG. 1, operation information of a subject can be obtained by capturing and analyzing the pictures of the subjects to detect operation information of the subject. Thus, the detection device 1 in the embodiment of FIG. 1 can be applied for movable or vibratile objects to detect operation states or for living bodies to detect operations of organs or physiological actions by a remote detection manner without touching the objects and the living bodies. In the following, several examples of the application of the detection device in FIG. 1 are shown.

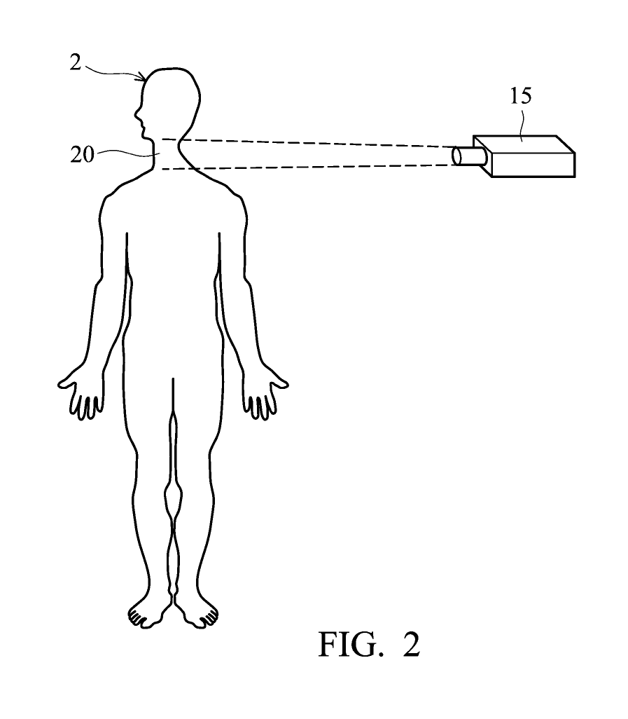

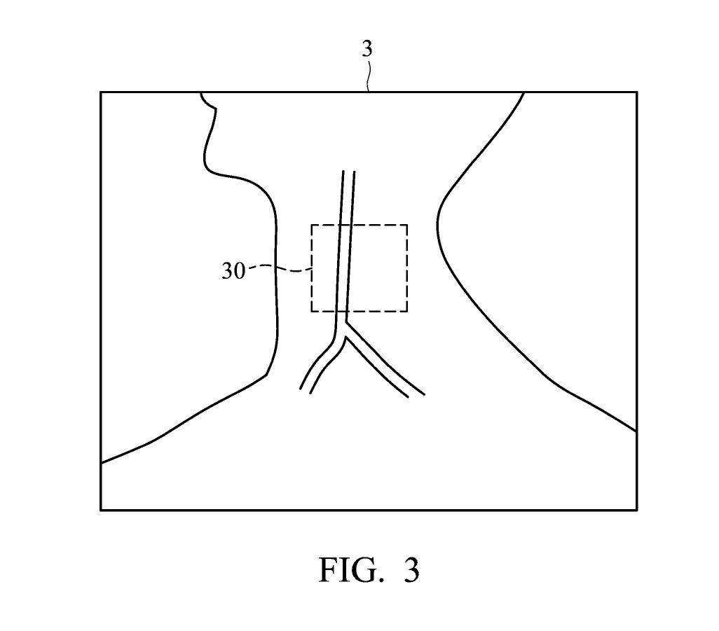

The detection device 1 applied for a living body is given as the first example. Referring to FIG. 2, the subject is a human. The image capturing unit 10 captures a plurality of pictures with the neck 20 of the human 2 via the camera 15 to generate image signals IS respectively. Referring to FIG. 3, after capturing the pictures of the human 2, for each picture of the subject, the image capturing unit 10 selects a specific area 30 of the picture 3 corresponding to the skin of the neck 20 near the carotid artery of the human 2. The image capturing unit 10 then generates a corresponding image signal IS according to the image of the specific area 30 of the picture 3. The image processing unit 11 receives the image signals IS and sums the gray-level values of each of the image signals IS to obtain a brightness value BV of the corresponding image signal. The memory unit 12 is coupled to the image processing unit 11 and receives the brightness values BV from the image processing unit 11. When the memory unit 12 collects the brightness values BV of a predetermined number, the memory unit 12 outputs the brightness values BV of the predetermined number to the signal processing unit 13. The signal processing unit 13 then generates an action signal according to the brightness values BV. The filter 130 of the signal processing unit 13 removes a non-periodic component of the action signal by an iterative Gaussian smoothing method. Then, the calculator 131 calculates a spectrum of the action signal by performing a Fast Fourier Transform algorithm to the action signal whose non-periodic component is removed.

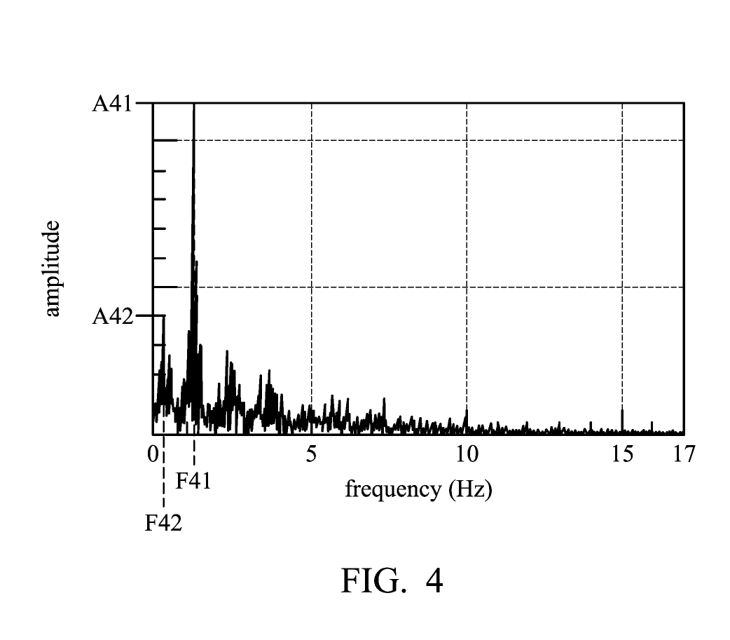

FIG. 4 shows the spectrum for the neck 20 of the human 2. After the spectrum is obtained, the detection unit 14 checks the spectrum according to a detection rule to obtain the specific operation information of the human 2. In the first example, according the detection rule, the detection unit 14 looking for a frequency range of 0-5 Hz in the spectrum and determines the greatest frequency amplitude A41 and the second greatest frequency amplitude A42 in the spectrum. The frequency F41 corresponding to the greatest frequency amplitude A41 is the undulation frequency of the skin of the neck 20 near the carotid artery, and the frequency F42 corresponding to the second greatest frequency amplitude A42 is the moving frequency of the neck 20. It knows that the pulse of the carotid artery induces undulation of the skin of the neck near the carotid artery. Moreover, the breathing of the human induces movement of the neck. Thus, the detection unit 14 can obtain the pulse rate and the respiratory rate of the human 2 according to the specific operation information of the human 2, that is according to the undulation frequency of the skin of the neck 20 near the carotid artery and the moving frequency of the neck 20 respectively. In some embodiments, the pulse rate is approximately equal to the undulation frequency of the skin of the neck near the carotid artery, and the respiratory rate of the human is approximately equal to the moving frequency of the neck.

In the first example, the frequency range and the determined frequency amplitudes are determined according to the pulse and the breathing of the human 2. In general, the pulse rate and the respiratory rate of a human in a normal state are 60˜90 times minute and 15˜45 times per minute respectively, and the pulse rate and the respiratory rate of a human which is exercising are 100˜150 times per minute and 30˜90 times per minute. Thus, the frequency range for detection is set as 0˜5 Hz.

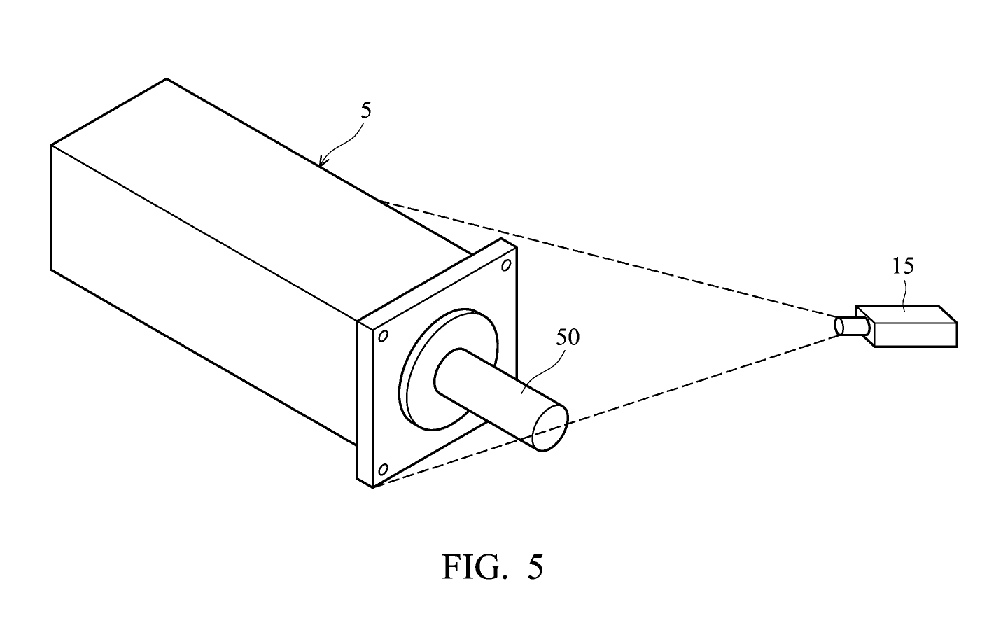

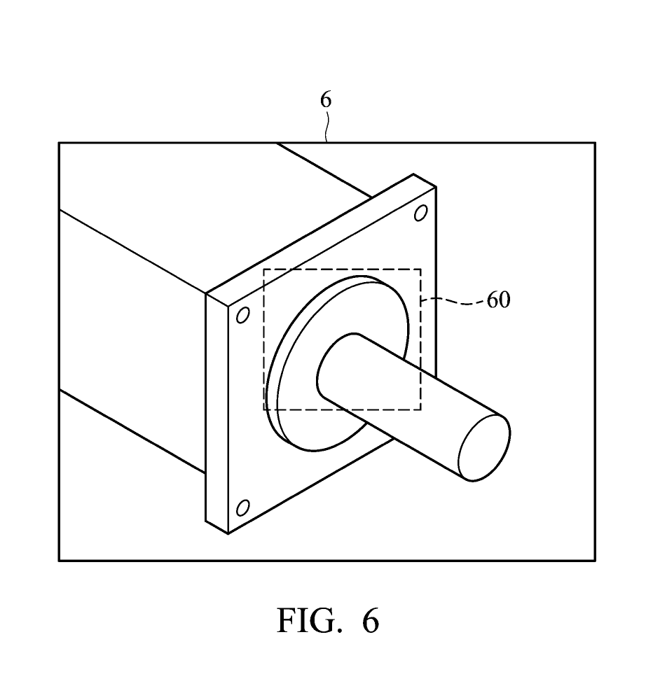

The detection device 1 applied for an object is given as the second example. Referring to FIG. 5, the subject is a servo-motor 5. The image capturing unit 10 captures a plurality of pictures of the servo-motor 5 via the camera 15 to generate image signals IS respectively. Referring to FIG. 6, after capturing the pictures of the servo-motor 5, for each picture of the subject, the image capturing unit 10 selects a specific area 60 of the picture 6 corresponding to a shaft 50 of the servo-motor 5. The image capturing unit 10 then generates a corresponding image signal IS according to an image of the specific area 60 of the picture. Then, the image processing unit 11, the memory 12, and the signal processing unit 13 perform the same operations as the first example, thus omitting the related description.

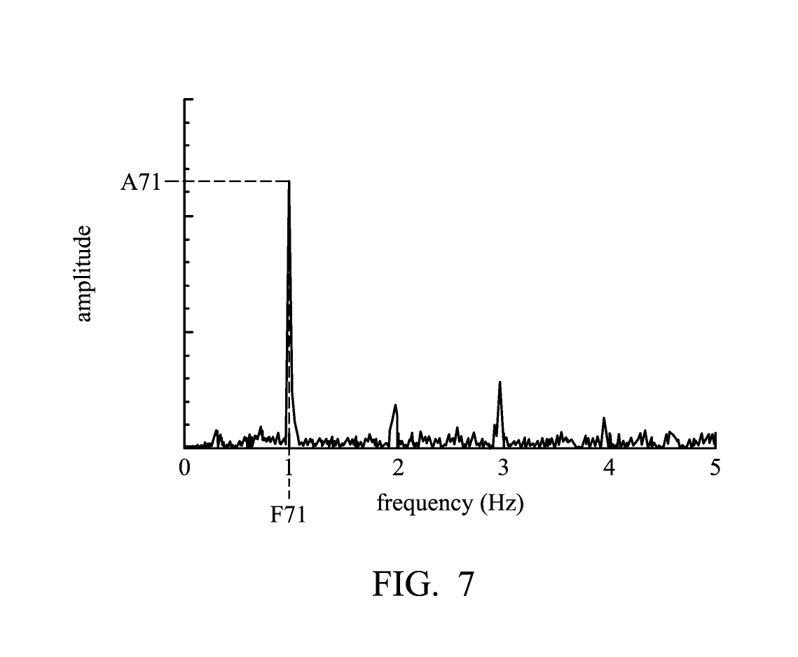

FIG. 7 shows the spectrum for the shaft 50 of the servo-motor 5. After the spectrum is obtained, the detection unit 14 checks the spectrum according to a detection rule to obtain the specific operation information of the servo-motor 5. In the second example, according the detection rule, the detection unit 14 determines the greatest frequency amplitude A71. The frequency F71 corresponding to the greatest frequency amplitude A71 is the vibration rate of the servo-motor 5. It knows that the rotation of the shaft 50 induces the vibration of the servo-motor 5. Thus, the detection unit 14 can obtain the rotation rate of the shaft 50 according to the specific operation information of the servo-motor 5, that is according to the vibration rate of the servo-motor 5. In some embodiments, the rotation rate of the shaft 50 is approximately equal to the vibration rate of the servo-motor 5.

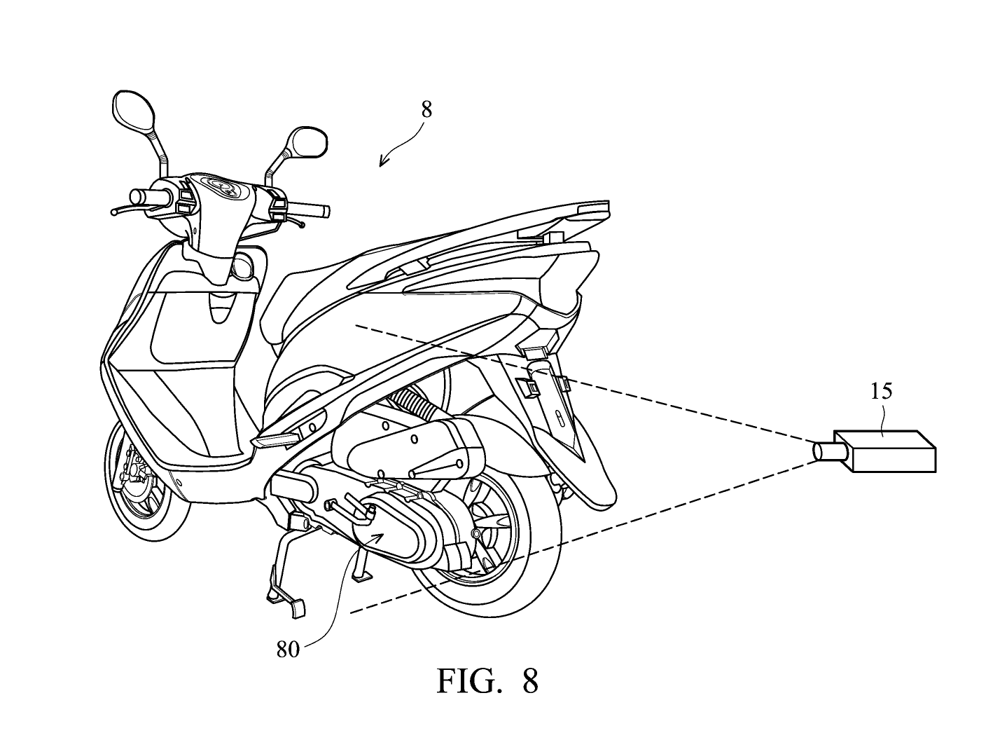

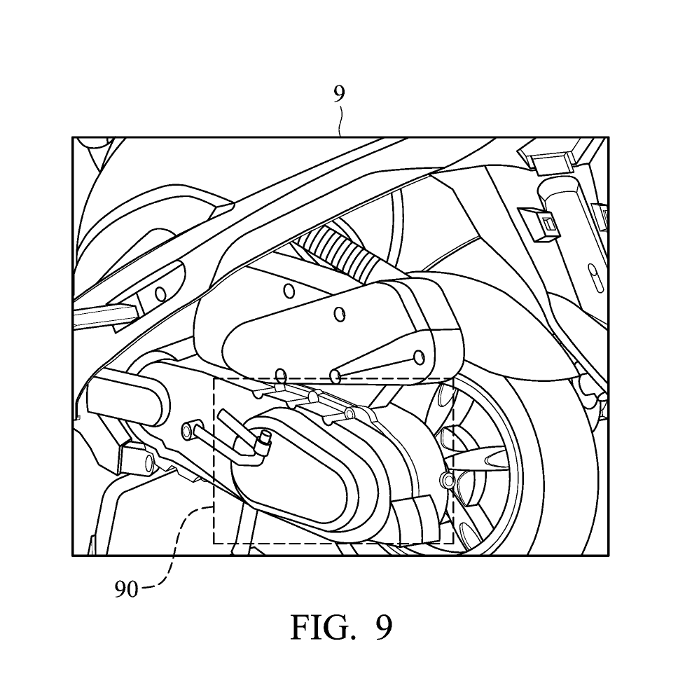

The detection device 1 applied for an object is given as the third example. Referring to FIG. 8, the subject is a motorcycle 8. The image capturing unit 10 captures a plurality of pictures of the motorcycle 8 via the camera 15 to generate image signals IS respectively. Referring to FIG. 9, after capturing the pictures of the motorcycle 8, for each picture of the subject, the image capturing unit 10 selects a specific area 90 of the picture 9 corresponding to an engine 80 of the motorcycle 8. The image capturing unit 10 then generates a corresponding image signal IS according to an image of the specific area 90 of the picture. Then, the image processing unit 11, the memory 12, and the signal processing unit 13 perform the same operations as the first example, thus omitting the related description.

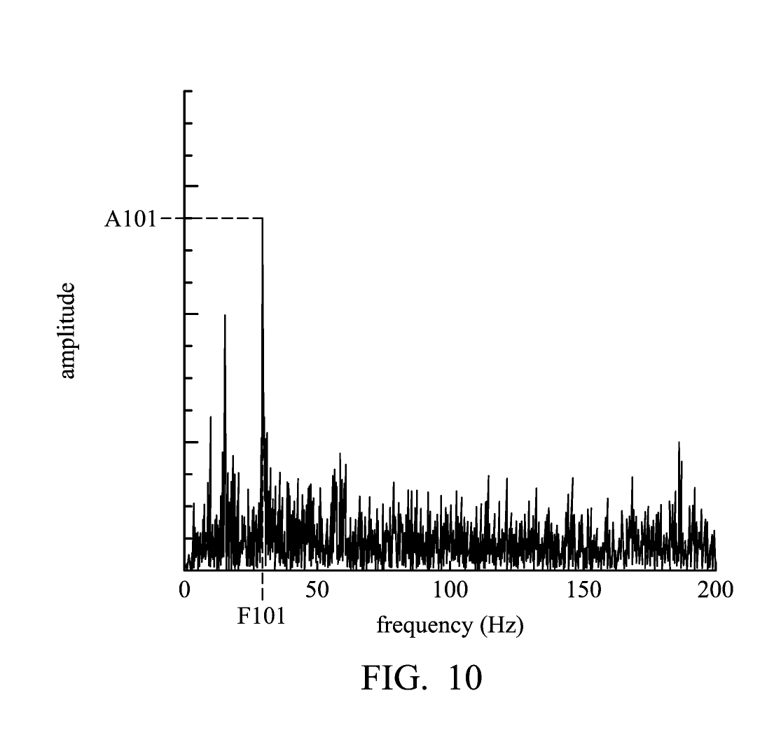

FIG. 10 shows the spectrum for the engine 80 of the motorcycle 8. After the spectrum is obtained, the detection unit 14 checks the spectrum according to a detection rule to obtain the specific operation information of the motorcycle 8. In the third example, according the detection rule, the detection unit 14 determines the greatest frequency amplitude A101. The frequency F101 corresponding to the greatest frequency amplitude A101 is the vibration rate of the engine 80. It knows that the operation in idle state of the motorcycle 8 induces the vibration of the engine 80. Thus, the detection unit 14 can obtain the idle speed of the engine 80 according to the specific operation information of the motorcycle 8, that is according to the vibration rate of the engine 80. In some embodiments, the idle speed of the engine 80 is approximately equal to the vibration rate of the engine 80. In other some embodiments, the detection unit 14 can also obtain the moving speed of the motorcycle 8 according to the vibration rate of the engine 80.

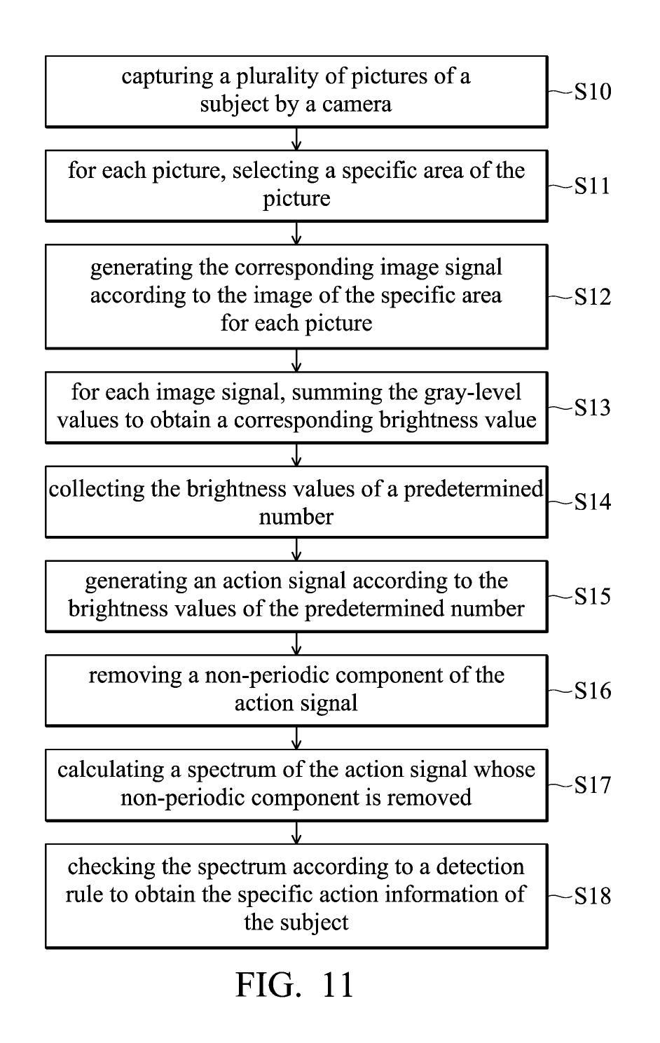

FIG. 11 shows an exemplary embodiment of a detection method. In the following, the detection method is described according to FIGS. 1 and 11. First, the image capturing unit 10 captures a plurality of pictures of a subject by the camera 15 (step S10). For each picture of the subject, the image capturing unit 10 then selects a specific area of the picture (step S11) and generates the corresponding image signal IS according to the image of the specific area of the picture (step S12). In the embodiment, each image signal IS comprises a plurality of gray-level values. For each image signal IS, the image processing unit 11 sums the gray-level values of the image signal IS to obtain a corresponding brightness value BV (step S13). The memory unit 12 receives the brightness values BV from the image processing unit 11. When the memory unit 12 collects the brightness values BV of a predetermined number (step S14), the signal processing unit 13 receives the brightness values BV of the predetermined number and generates an action signal according to the received brightness values BV (step S15). In the embodiment, the action signal is composed of the brightness values BV of the predetermined number. Then, the filter 130 of the signal processing unit 13 removes a non-periodic component of the action signal (step S16), and the calculator 131 of the signal processing unit 13 calculates a spectrum of the action signal whose non-periodic component is removed (step S17). The detection unit 14 checks the spectrum according to a detection rule to obtain the specific operation information of the subject (step S18).

In another embodiment, if the subject is a living body, the specific operation information comprises an undulation frequency of skin of a neck near the carotid artery of the living body. The detection unit 14 can obtain the pulse rate of the living body according to the undulation frequency. Moreover, the specific operation information may further comprise a moving frequency of the neck of the living body, and the detection unit 14 can obtain the respiratory rate of the living body according to the moving frequency.

In another embodiment, if the subject has a shaft, the specific operation information comprises a vibration rate of the subject. The detection unit 14 can obtain a rotation rate of the shaft according to the vibration rate of the subject.

In further another embodiment, if the subject has an engine, the specific operation information comprises a vibration rate of the engine. The detection unit 14 can obtain an idle speed of the engine according to the vibration rate of the engine.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A detection device for detecting specific operation information of a subject comprising:
an image capturing unit for capturing a plurality of pictures of the subject to generate image signals respectively, wherein each of the image signals comprises a plurality of gray-level values;
an image processing unit for receiving the image signals and summing the gray-level values of each of the image signals to obtain a brightness value of the corresponding image signal;
a signal processing unit for receiving the brightness values, generating an action signal according to the brightness values, removing a non-periodic component of the action signal, and calculating a spectrum of the action signal whose non-periodic component is removed; and
a detection unit for checking the spectrum according to a detection rule to obtain the specific operation information of the subject.

2. The detection device as claimed in claim 1 further comprising a memory unit, coupled to the image processing unit, for receiving the brightness values from the image processing unit, wherein when the memory unit collects the brightness values of a predetermined number, the memory unit outputs the brightness values of the predetermined number to the signal processing unit.

3. The detection device as claimed in claim 2, wherein the action signal is composed of the brightness values of the predetermined number.

4. The detection device as claimed in claim 1, wherein for each of the pictures of the subject, the image capturing unit selects a specific area of the picture and generates the corresponding image signal according to an image of the specific area of the picture.

5. The detection device as claimed in claim 1, wherein the signal processing unit comprises:
a filter for removing the non-periodic component of the action signal; and
a calculator for calculating the spectrum of the action signal whose non-periodic component is removed.

6. The detection device as claimed in claim 5, wherein the filter removes the non-periodic component of the action signal by an iterative Gaussian smoothing method.

7. The detection device as claimed in claim 5, wherein the calculator calculates the spectrum of the action signal whose non-periodic component is removed by performing a Fast Fourier Transform algorithm.

8. The detection device as claimed in claim 1, wherein the subject is a living body, and the specific operation information comprises an undulation frequency of skin of a neck near a carotid artery of the living body.

9. The detection device as claimed in claim 8, wherein the detection unit obtains a pulse rate of the living body according to the undulation frequency.

10. The detection device as claimed in claim 1, wherein the subject is a living body, and the specific operation information comprises a moving frequency of a neck of the living body.

11. The detection device as claimed in claim 10, wherein the detection unit obtains a respiratory rate of the living body according to the moving frequency.

12. The detection device as claimed in claim 1, wherein the subject has a shaft, and the specific operation information comprises a vibration rate of the subject.

13. The detection device as claimed in claim 12, wherein the detection unit obtains a rotation rate of the shaft according to the vibration rate of the subject.

14. The detection device as claimed in claim 1, wherein the subject has an engine, and the specific operation information comprises a vibration rate of the engine.

15. The detection device as claimed in claim 14, wherein the detection unit obtains an idle speed of the engine according to the vibration rate of the engine.

16. The detection device as claimed in claim 1, wherein the detection rule comprises at least one of looking for a frequency range in the spectrum and determining a frequency amplitude in the frequency range.

17. A detection method for detecting specific operation information of a subject comprising:
capturing a plurality of pictures of the subject to obtain image signals respectively, wherein each of the image signals comprises a plurality of gray-level values;
for each of the image signals, summing the gray-level values of the image signal to obtain a brightness value;
generating an action signal according to the brightness values;
removing a non-periodic component of the action signal;
calculating a spectrum of the action signal whose non-periodic component is removed; and
checking the spectrum according to a detection rule to obtain the specific operation information of the subject.

18. The detection method as claimed in claim 17 further comprising for collecting the brightness values of a predetermined number, wherein the action signal is composed of the brightness values of the predetermined number.

19. The detection method as claimed in claim 17, wherein the step of capturing the pictures of the subject comprises:
for each of the pictures of the subject, selecting a specific area of the picture; and
generating the corresponding image signal according to an image of the specific area of the picture.

20. The detection method as claimed in claim 17, wherein in the step of removing the non-periodic component, the non-periodic component of the action signal is removed by an iterative Gaussian smoothing method.

21. The detection method as claimed in claim 17, wherein in the step of calculating the spectrum, the spectrum of the action signal whose non-periodic component is removed is calculated by performing a Fast Fourier Transform algorithm.

22. The detection method as claimed in claim 17, wherein the subject is a living body, and the specific operation information comprises an undulation frequency of skin of a neck near a carotid artery of the living body.

23. The detection method as claimed in claim 22 further comprising obtaining a pulse rate of the living body according to the undulation frequency.

24. The detection method as claimed in claim 17, wherein the subject is a living body, and the specific operation information comprises a moving frequency of a neck of the living body.

25. The detection method as claimed in claim 24, wherein the detection unit obtains a respiratory rate of the living body according to the moving frequency.

26. The detection method as claimed in claim 17, wherein the subject has a shaft, and the specific operation information comprises a vibration rate of the subject.

27. The detection method as claimed in claim 26 further comprising obtaining a rotation rate of the shaft according to the vibration rate of the subject.

28. The detection method as claimed in claim 17, wherein the subject has an engine, and the specific operation information comprises a vibration rate of the engine.

29. The detection method as claimed in claim 28 further comprising obtaining an idle speed of the engine according to the vibration rate of the engine.

30. The detection method as claimed in claim 17, wherein the detection rule comprises at least one of looking for a frequency range in the spectrum and determining a frequency amplitude in the frequency range.
